(19) United States
(12) Patent Application Publication
(10) Pub. No.: US 2024/0331093 A1
(43) Pub. Date: Oct. 3, 2024

(54) METHOD OF TRAINING FUSION MODEL, METHOD OF FUSING IMAGE, DEVICE, AND STORAGE MEDIUM

(71) Applicant: BEIJING BAIDU NETCOM SCIENCE TECHNOLOGY CO., LTD., Beijing (CN)

(72) Inventors: Zhiliang XU, Beijing (CN); Zhibin HONG, Beijing (CN)

(73) Assignee: BEIJING BAIDU NETCOM SCIENCE TECHNOLOGY CO., LTD., Beijing (CN)

(21) Appl. No.: 18/020,891

(22) PCT Filed: Jun. 9, 2022
(86) PCT No.: PCT/CN2022/097872

§ 371 Date: Feb. 10, 2023

(30) Foreign Application Priority Data
Sep. 30, 2021 (CN) 202111168236.2

(51) Int. Cl. G06T 5/50; G06V 10/24

(52) U.S. Cl. CPC G06T 5/50; G06V 10/245; G06T 2207/20081; G06T 2207/20221

(57) ABSTRACT

A method of training a fusion model, a method of fusing an image, an electronic device, and a storage medium are provided, which relate to a field of an artificial intelligence technology, in particular to fields of computer vision and deep learning technologies, and may be applied to face image processing, face recognition and other scenarios. A specific implementation solution includes: inputting a training source image and a training template image into a fusion model to obtain a training fusion image; performing an attribute alignment transformation on the training fusion image to obtain a training aligned image, wherein an attribute information of the training aligned image is consistent with an attribute information of the training source image; and training the fusion model using an identity loss function, wherein the identity loss function is generated for the training source image and the training aligned image.

This application claims priority to Chinese Patent Application No. 202111168236.2 filed on Sep. 30, 2021, which is incorporated herein by reference in its entirety.

### TECHNICAL FIELD

The present disclosure relates to a field of an artificial intelligence technology, in particular to fields of computer vision and deep learning technologies, and may be applied to face image processing, face recognition and other scenarios. Specifically, the present disclosure relates to a method and an apparatus of training a fusion model, a method and an apparatus of fusing an image, an electronic device, a storage medium, and a program product.

### BACKGROUND

An image fusion may refer to a technology of combining two or more images into a new image. The image fusion may make use of a correlation and a complementarity between a plurality of images, so that the new image obtained by fusion has a more comprehensive and clear content display, which is beneficial to identification and detection. The image fusion may provide a great help for an application development of public security, information security and financial security.

### SUMMARY

The present disclosure provides a method and an apparatus of training a fusion model, a method and an apparatus of fusing an image, an electronic device, a storage medium, and a program product.

According to an aspect of the present disclosure, a method of training a fusion model is provided, including: inputting a training source image and a training template image into a fusion model to obtain a training fusion image; performing an attribute alignment transformation on the training fusion image to obtain a training aligned image, wherein an attribute information of the training aligned image is consistent with an attribute information of the training source image; and training the fusion model using an identity loss function, wherein the identity loss function is generated for the training source image and the training aligned image.

According to another aspect of the present disclosure, a method of fusing an image is provided, including: inputting an image to be fused and a template image into a fusion model to obtain a fusion image; wherein the fusion model is trained by using the method of training the fusion model as described above.

According to another aspect of the present disclosure, an apparatus of training a fusion model is provided, including: a training fusion module configured to input a training source image and a training template image into a fusion model to obtain a training fusion image; an attribution transformation module configured to perform an attribute alignment transformation on the training fusion image to obtain a training aligned image, wherein an attribute information of the training aligned image is consistent with an attribute information of the training source image; and a training module configured to train the fusion model using an identity loss function, wherein the identity loss function is generated for the training source image and the training aligned image.

According to another aspect of the present disclosure, an apparatus of fusing an image is provided, including: a fusion module configured to input an image to be fused and a template image into a fusion model to obtain a fusion image; wherein the fusion model is trained by using the method of training the fusion model as described above.

According to another aspect of the present disclosure, an electronic device is provided, including: at least one processor; and a memory communicatively connected to the at least one processor, wherein the memory stores instructions executable by the at least one processor, and the instructions, when executed by the at least one processor, cause the at least one processor to implement the methods described above.

According to another aspect of the present disclosure, a non-transitory computer-readable storage medium having computer instructions therein is provided, and the computer instructions are configured to cause a computer to implement the methods described above.

According to another aspect of the present disclosure, a computer program product containing a computer program is provided, and the computer program, when executed by a processor, causes the processor to implement the methods described above.

It should be understood that content described in this section is not intended to identify key or important features in embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used for better understanding of the solution and do not constitute a limitation to the present disclosure, in which:

FIG. 1 schematically shows an exemplary system architecture to which a method and an apparatus of fusing an image may be applied according to embodiments of the present disclosure;

FIG. 2 schematically shows a flowchart of a method of training a fusion model according to embodiments of the present disclosure;

FIG. 3 schematically shows a schematic flowchart of a method of training a fusion model according to other embodiments of the present disclosure;

FIG. 4 schematically shows a schematic flowchart of a method of training a fusion model according to other embodiments of the present disclosure;

FIG. 5 schematically shows a flowchart of a method of fusing an image according to embodiments of the present disclosure;

FIG. 6 schematically shows a flowchart of a method of fusing an image according to other embodiments of the present disclosure;

FIG. 7 schematically shows a block diagram of an apparatus of training a fusion model according to embodiments of the present disclosure;

FIG. 8 schematically shows a block diagram of an apparatus of fusing an image according to embodiments of the present disclosure; and

FIG. 9 schematically shows a block diagram of an electronic device suitable for implementing a method of fusing an image according to embodiments of the present disclosure.

### DETAILED DESCRIPTION OF EMBODIMENTS

Exemplary embodiments of the present disclosure will be described below with reference to accompanying drawings, which include various details of embodiments of the present disclosure to facilitate understanding and should be considered as merely exemplary. Therefore, those ordinary skilled in the art should realize that various changes and modifications may be made to embodiments described herein without departing from the scope and spirit of the present disclosure. Likewise, for clarity and conciseness, descriptions of well-known functions and structures are omitted in the following description.

The present disclosure provides a method and an apparatus of training a fusion model, a method and an apparatus of fusing an image, an electronic device, a storage medium, and a program product.

According to embodiments of the present disclosure, the method of training the fusion model may include: inputting a training source image and a training template image into a fusion model to obtain a training fusion image; performing an attribute alignment transformation on the training fusion image to obtain a training aligned image, an attribute information of the training aligned image is consistent with an attribute information of the training source image; and training the fusion model using an identity loss function, and the identity loss function is generated for the training source image and the training aligned image.

According to embodiments of the present disclosure, the method of fusing the image includes inputting an image to be fused and a template image into a fusion model to obtain a fusion image. The fusion model is trained by using the method of training the fusion model provided by embodiments of the present disclosure.

In the technical solutions of the present disclosure, a collection, a storage, a use, a processing, a transmission, a provision, a disclosure and other processing of user personal information involved comply with provisions of relevant laws and regulations, with necessary security measures being taken, and do not violate public order and good custom.

In the technical solutions of the present disclosure, the acquisition or collection of user personal information has been authorized or allowed by users.

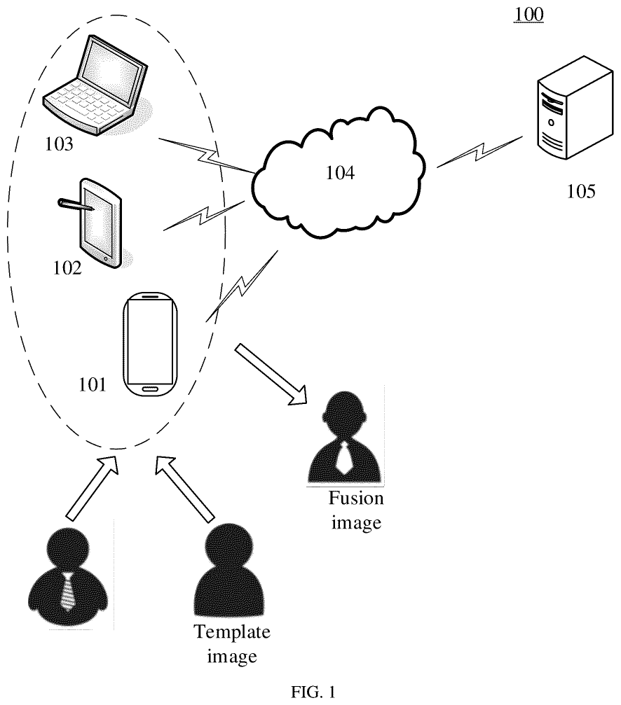

FIG. 1 schematically shows an exemplary system architecture to which a method and an apparatus of fusing an image may be applied according to embodiments of the present disclosure.

It should be noted that FIG. 1 is merely an example of a system architecture to which embodiments of the present disclosure may be applied to help those skilled in the art understand the technical contents of the present disclosure, but it does not mean that embodiments of the present disclosure may not be applied to other devices, systems, environments or scenarios. For example, in other embodiments, an exemplary system architecture to which a method and an apparatus of fusing an image may be applied may include a terminal device, but the terminal device may implement the method and the apparatus of fusing the image provided in embodiments of the present disclosure without interacting with a server.

As shown in FIG. 1, a system architecture 100 according to such embodiments may include terminal devices 101, 102 and 103, a network 104, and a server 105. The network 104 is used as a medium for providing a communication link between the terminal devices 101, 102, 103 and the server 105. The network 104 may include various connection types, such as wired and/or wireless communication links, and the like.

The terminal devices 101, 102 and 103 may be used by a user to interact with the server 105 through the network 104, so as to send a source image and a template image, and receive a fusion image. The terminal devices 101, 102 and 103 may be installed with various communication client applications, such as an application program loaded with a method of fusing an image (for example only) or the like.

The terminal devices 101, 102 and 103 may be various electronic devices with display screens and cameras, including but not limited to smartphones, tablet computers, laptop computers, desktop computers, and the like.

The server 105 may be a server providing various services, such as a background management server (for example only) that provides a support for the source image and the template image uploaded by the user using the terminal devices 101, 102 and 103.

The background management server may perform an image fusion on the source image and the template image to obtain a fusion image, and feed back the fusion image to the terminal devices.

It should be noted that the method of fusing the image provided by embodiments of the present disclosure may generally be performed by the terminal device 101, 102 or 103. Accordingly, the apparatus of fusing the image provided by embodiments of the present disclosure may also be arranged in the terminal device 101, 102 or 103.

Alternatively, the method of fusing the image provided by embodiments of the present disclosure may generally be performed by the server 105. Accordingly, the apparatus of fusing the image provided by embodiments of the present disclosure may be generally arranged in the server 105. The method of fusing the image provided by embodiments of the present disclosure may also be performed by a server or server cluster different from the server 105 and capable of communicating with the terminal devices 101, 102, 103 and/or the server 105. Accordingly, the apparatus of fusing the image provided by embodiments of the present disclosure may also be arranged in a server or server cluster different from the server 105 and capable of communicating with the terminal devices 101, 102, 103 and/or the server 105.

It should be understood that a number of terminal devices, network and server in FIG. 1 are merely schematic. According to implementation needs, any number of terminal devices, networks and servers may be provided.

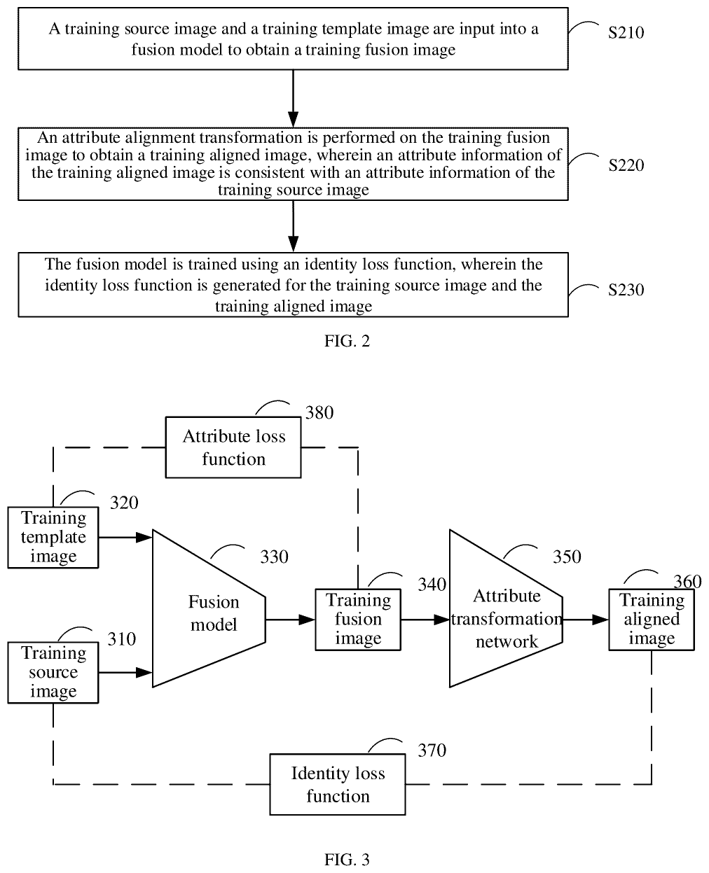

FIG. 2 schematically shows a flowchart of a method of training a fusion model according to embodiments of the present disclosure.

As shown in FIG. 2, the method includes operations S210 to S230.

In operation S210, a training source image and a training template image are input into a fusion model to obtain a training fusion image.

In operation S220, an attribute alignment transformation is performed on the training fusion image to obtain a training aligned image, and an attribute information of the training aligned image is consistent with an attribute information of the training source image.

In operation S230, the fusion model is trained using an identity loss function, and the identity loss function is generated for the training source image and the training aligned image.

According to embodiments of the present disclosure, the training source image may be an image to be fused, and may include a source human face object. However, the training source image is not limited thereto and may also include a source animal face object or other source objects.

According to embodiments of the present disclosure, the training template image may be a target image and may include a target human face object. However, the training template image is not limited thereto and may also include a target animal face object or other target objects.

It should be noted that the number of training template images is not limited. For example, one or more template images may be provided, as long as the template images may be input into the fusion model with the training source image to obtain the training fusion image.

According to embodiments of the present disclosure, the training source image and the training template image may be fused by using the fusion model to generate the training fusion image.

For example, by using the fusion model, an identity information of the training source image may be transferred to the training template image, while an attribute information of the training template image is kept unchanged.

According to embodiments of the present disclosure, the fusion model may be trained by constraining an identity similarity between the identity information of the training aligned image and the identity information of the training source image. For example, an identity loss function for the training aligned image and the training source image may be generated, and the fusion model may be trained using the identity loss function.

According to embodiments of the present disclosure, a method of an attribute alignment transformation may be used, and the attribute alignment transformation may be performed on the attribute information of the training fusion image to generate the training aligned image. The attribute information of the training aligned image is consistent with the attribute information of the training source image. Furthermore, in a case of calculating an identity loss value between the identity information of the training aligned image and the identity information of the training source image by using the identity loss function, an interference of the attribute information between the two has been eliminated, and only the identity information is involved. In this way, in a process of training the fusion model using the identity loss function, an anti-noise introduced due to inconsistent attribute information may not be generated, so that a feasibility and a stability of the training of the fusion model may be improved.

In embodiments of the present disclosure, a training source image and a training template image related to a human face object are acquired through various open, legal and compliant methods, for example, from a public dataset or authorized by a user corresponding to a human face image.

It should be noted that, in embodiments of the present disclosure, the fusion model is not for a specific user, and may not reflect a personal information of a specific user. A construction of the fusion model is performed after authorization by users, and a construction process complies with relevant laws and regulations.

The method of training the fusion model shown in FIG. 2 will be further described below in conjunction with specific embodiments and with reference to FIG. 3 to FIG. 6.

According to embodiments of the present disclosure, in operation S220, the attribute alignment transformation is performed on the training fusion image to obtain the training aligned image. The attribute alignment transformation may include, for example, one or more selected from a pose attribute alignment transformation, a makeup attribute alignment transformation, or an expression attribute alignment transformation. However, the attribute alignment transformation is not limited to the above, and may further include an age attribute alignment transformation, a head shape attribute alignment transformation, and so on.

According to embodiments of the present disclosure, the pose attribute alignment transformation may refer to changing a face pose, for example, simulating different facial poses or transforming a face into a frontal view.

According to embodiments of the present disclosure, the makeup attribute alignment transformation may refer to changing a makeup, for example, migrating the makeup.

According to embodiments of the present disclosure, the expression attribute alignment transformation may refer to changing an expression of a face, including an expression of a lip, a nose and other image regions meaningful for an expression synthesis.

According to embodiments of the present disclosure, the attribute alignment transformation may be performed on the training fusion image by using various attribute transformation networks.

According to exemplary embodiments of the present disclosure, it is possible to use a multi-attribute alignment transformation model, for example, a multi-attribute alignment transformation model formed by combining StyleGAN (Style Generative Adversarial Network) and 3DMM (3D Morphable Model).

By performing the attribute alignment transformation on the training fusion image using the multi-attribute alignment transformation model provided by embodiments of the present disclosure, it is possible to quickly edit and process the attribute alignment transformation of various attribute information, so that the generated training aligned image and the training source image may meet requirements of consistent pose attribute information, consistent makeup attribute information and consistent expression attribute information at the same time.

According to embodiments of the present disclosure, an attribute feature vector of the training fusion image and an attribute feature vector of the training source image may be simultaneously input as input data into the multi-attribute alignment transformation model to obtain the training aligned image that has been processed by the attribute alignment transformation. The training aligned image is constrained by the attribute feature vector of the training source image, so that the attribute information of the training aligned image is consistent with the attribute information of the training source image. Then, the identity loss value obtained by using the identity information of the training aligned image and the identity information of the training source image may not introduce additional attribute information, so that an interference of the attribute information may be reduced, and a training success rate of the fusion image may be improved.

According to embodiments of the present disclosure, in operation S230, during the process of training the fusion model using the identity loss function, a plurality of training samples may be acquired according to actual needs, and each training sample may include a training source image and a training template image. A source object in the training source image and a target object in the training template image may have a same category (e.g., a category of human face or a category of animal face), different attribute information, and different identity information.

According to embodiments of the present disclosure, the identity loss value between the identity information of the training aligned image and the identity information of the training source image may be calculated using the identity loss function generated for the training aligned image and the training source image, and a parameter of the fusion model may be adjusted based on the identity loss value until the identity loss value meets a predetermined identity loss threshold. A fusion model with the identity loss value meeting the predetermined identity loss threshold may be used as a trained fusion model, for example, a fusion model with an identity loss value greater than or equal to the predetermined identity loss threshold may be used as a trained fusion model, so that the trained fusion model is used as an application model for an image fusion.

According to exemplary embodiments of the present disclosure, a fusion model may also be trained by using a combination of an identity loss function and an attribute loss function, so that the identity information of the training aligned image may be consistent with the identity information of the training source image, and the attribute information of the training fusion image may be consistent with the attribute information of the training template image.

FIG. 3 schematically shows a flowchart of a method of training a fusion model according to other embodiments of the present disclosure.

As shown in FIG. 3, a training source image 310 and a training template image 320 may be input into a fusion model 330 to obtain a training fusion image 340. An attribute alignment transformation is performed on the training fusion image 340, for example, the training fusion image 340 is input into an attribute transformation network 350 to obtain a training aligned image 360. An identity loss function 370 is generated for the training source image 310 and the training aligned image 360. An attribute loss function 380 is generated for the training fusion image 340 and the training template image 320. A joint loss function is determined based on the identity loss function 370 and the attribute loss function 380. The fusion model is trained using the joint loss function.

According to embodiments of the present disclosure, the attribute loss function may be a feature matching loss function in the generative adversarial network series (GAN Feature Matching). However, the attribute loss function is not limited thereto and may also be other feature matching loss functions, as long as it is a loss function that may be used to constrain an attribute consistency between the attribute information of the training template image and the attribute information of the training fusion image.

According to embodiments of the present disclosure, the identity loss function may be an ArcFace loss function. However, the identity loss function is not limited thereto and may also be other feature matching loss functions, as long as it is a loss function that may be used to constrain an identity consistency between the identity information of the training source image and the identity information of the training aligned image.

According to embodiments of the present disclosure, a joint loss function L may be determined by combining, for example, adding, an attribute loss function L₁ and an identity loss function L₂. For example, L=L₁+L₂. However, it is not limited to this. It is also possible to configure weights for the attribute loss function and the identity loss function, and combine the attribute loss function and the identity loss function with their corresponding weights W₁ and W₂ to determine the joint loss function. For example, L=W₁*L₁+W₂*L₂.

According to embodiments of the present disclosure, training the fusion model using the joint loss function may include the following operations.

For example, a first identity information of the training source image and a second identity information of the training aligned image are acquired; the first identity information and the second identity information are input into the identity loss function to obtain an identity loss value; a first attribute information of the training template image and a second attribute information of the training fusion image are acquired; the first attribute information and the second attribute information are input into the identity loss function to obtain an attribute loss value; and the fusion model is trained based on the identity loss value and the attribute loss value.

According to embodiments of the present disclosure, training the fusion model based on the identity loss value and the attribute loss value may include the following operations.

For example, a joint loss value may be obtained based on the identity loss value and attribute loss value. The joint loss value is compared with a predetermined joint loss threshold, and a parameter of the fusion model may be adjusted in a case that the joint loss value does not meet the predetermined joint loss threshold. In a case that the joint loss value meets the predetermined joint loss threshold, for example, in a case that the joint loss value is greater than or equal to the predetermined joint loss threshold, it may indicate that the training of the fusion model is completed.

For another example, a joint loss value may be obtained based on the identity loss value and the attribute loss value. The parameter of the fusion model may be adjusted based on the joint loss value until the joint loss value converges. In a case that the joint loss value converges, it indicates that the training of the fusion model is completed.

According to embodiments of the present disclosure, the identity information of the training aligned image may be consistent with the identity information of the training source image, and the attribute information of the training fusion image output by the trained fusion model may be consistent with the attribute information of the training template image, so that the training fusion image and the training source image have an identity similarity, and the training fusion image and the training template image have an attribute similarity.

According to exemplary embodiments of the present disclosure, based on a generative adversarial network (GAN), the fusion model may be used as a generator, and combined with a discriminator, the fusion model may be further trained using a training method of a generative adversarial network.

According to embodiments of the present disclosure, the discriminator may be constructed based on a neural network, such as a deep neural network (DNN), a convolutional neural network (CNN), a recurrent neural network (RNN) and the like, which are not limited here, as long as the discriminator may be matched with the fusion model to achieve the generative adversarial network.

According to embodiments of the present disclosure, the training process of the generative adversarial network may include the following operations. For example, it is possible to fix the parameter of the fusion model and train the discriminator. The training fusion image output by the fusion model and the training source image may be used as discrimination training data for the discriminator, and the discriminator may be trained using the discrimination training data. After the discriminator is trained for multiple rounds, it is possible to train the fusion model one time, so that it is as difficult as possible for the discriminator to distinguish the training fusion image from the training source image.

According to embodiments of the present disclosure, after a plurality of training iterations, if an output probability of the discriminator is 0.5, it may be regarded that the training of the fusion model is completed.

According to embodiments of the present disclosure, by training the fusion model as a generator by the method of the generative adversarial network, the fusion model may output a more realistic fusion image, so that the fusion image may fit a real image.

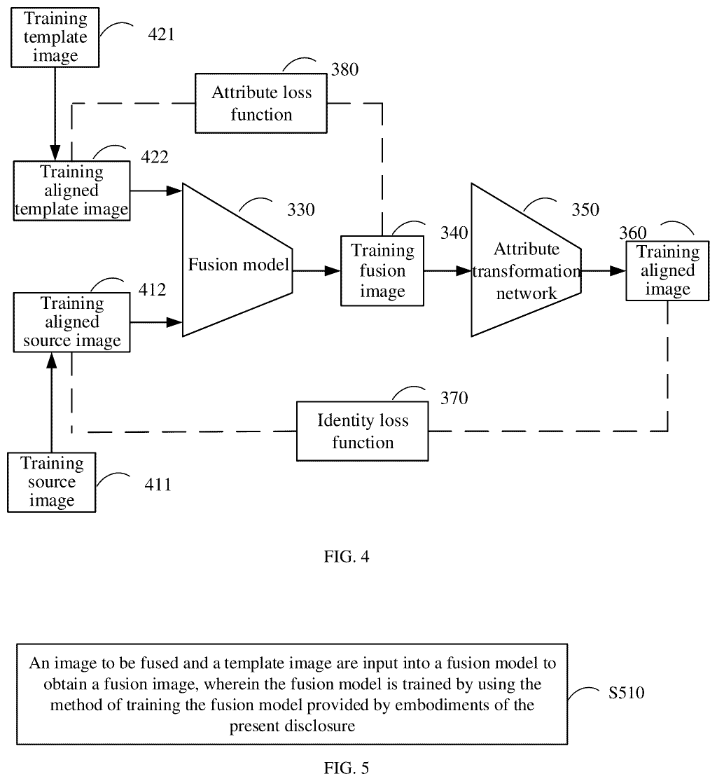

FIG. 4 schematically shows a flowchart of a method of training a fusion model according to other embodiments of the present disclosure.

The method of training the fusion model shown in FIG. 4 is different from the method of training the fusion model shown in FIG. 3 in that a key point alignment preprocessing is performed on the training source image and the training template image respectively. For example, a key point alignment may be performed on a training source image 411 to obtain a training aligned source image 412; a key point alignment may be performed on a training template image 421 to obtain a training aligned template image 422; and the training aligned source image 412 and the training aligned template image 422 may be input into the fusion model 330 to obtain the training fusion image 340. An attribute alignment transformation may be performed on the training fusion image 340, for example, the training fusion image 340 may be input into the attribute transformation network 350 to obtain the training aligned image 360. The identity loss function 370 may be generated for the training aligned source image 412 and the training aligned image 360. The attribute loss function 380 may be generated for the training fusion image 340 and the training aligned template image 422. A joint loss function may be determined based on the identity loss function 370 and the attribute loss function 380. The fusion model may be trained using the joint loss function.

According to exemplary embodiments of the present disclosure, a 5 facial key point detection may be performed on the training source image, and then ArcFace cropping may be performed to obtain a cropped training aligned source image with key points aligned.

According to exemplary embodiments of the present disclosure, a 72 facial key point detection may be performed on the training template image, and then FFHQ (Flickr-Faces-High-Quality, a high-quality image dataset of human faces) cropping may be performed to obtain a cropped training aligned template image with key points aligned.

With the key point alignment preprocessing operation provided by embodiments of the present disclosure, the image key points of the two images input into the fusion model may be aligned, for example, resolution and other information may be consistent, which is beneficial to a generation of the training fusion image by the fusion model and may increase a training speed of the fusion model. Moreover, it is also beneficial to extract the attribute information from the training aligned template image and extract the identity information from the training aligned source image, which facilitates the calculation of the identity loss value and the attribute loss value.

FIG. 5 schematically shows a flowchart of a method of fusing an image according to embodiments of the present disclosure.

As shown in FIG. 5, the method includes operation S510.

In operation S510, an image to be fused and a template image are input into a fusion model to obtain a fusion image, and the fusion model is trained by using the method of training the fusion model provided by embodiments of the present disclosure.

According to embodiments of the present disclosure, the image to be fused may include a source human face object, but is not limited thereto, and may also include a source animal face object or other source objects.

According to embodiments of the present disclosure, the template image may be a target image. The template image may include a target human face object, but is not limited thereto, and may also include a target animal face object or other target objects.

It should be noted that the number of template images is not limited. For example, one or more template images may be provided, as long as the template images may be input into the fusion model with the image to be fused to obtain a fusion image.

According to the embodiments of the present disclosure, by using the fusion model, the image to be fused and the template image may be fused to generate a fusion image.

By generating a fusion image using the fusion model trained by the method of training the fusion model provided by embodiments of the present disclosure according to the method of fusing the image provided by embodiments of the present disclosure, an identity similarity between the fusion image and the image to be fused may be improved, and artifacts and other problems in the fusion image caused by the interference of the attribute information may be reduced.

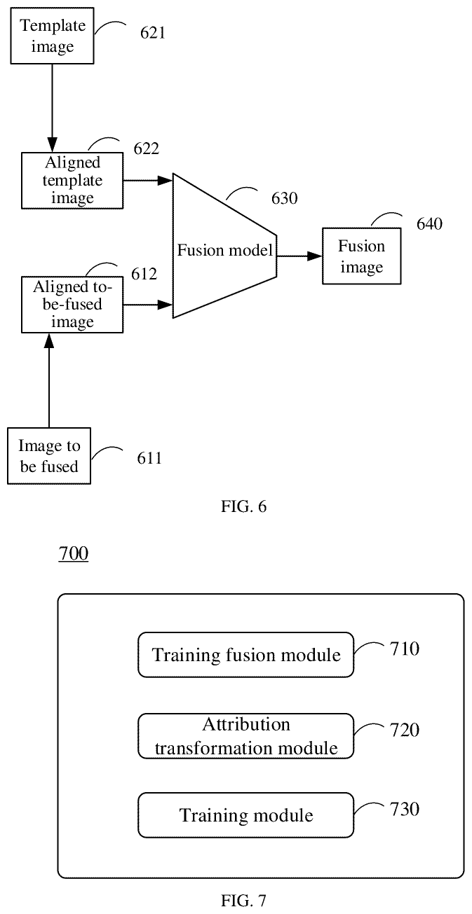

Referring to FIG. 6, the method of fusing the image shown in FIG. 5 will be further described in conjunction with specific embodiments.

FIG. 6 schematically shows a flowchart of a method of fusing an image according to other embodiments of the present disclosure.

As shown in FIG. 6, a key point alignment is performed on an image to be fused 611 to obtain an aligned to-be-fused image 612; a key point alignment is performed on a template image 621 to obtain an aligned template image 622; and the aligned to-be-fused image 612 and the aligned template image 622 are input into a fusion model 630 to obtain a fusion image 640.

According to exemplary embodiments of the present disclosure, a 5 facial key point detection may be performed on the image to be fused, and then ArcFace cropping may be performed to obtain a cropped aligned to-be-fused image with key points aligned.

According to exemplary embodiments of the present disclosure, a 72 facial key point detection may be performed on the template image, and then FFHQ (Flickr-Faces-High-Quality, a high-quality image dataset of human faces) cropping may be performed to obtain a cropped aligned template image with key points aligned.

With the key point alignment preprocessing operation provided by embodiments of the present disclosure, the image key points of the two images input into the fusion model may be aligned, for example, resolution and other information may be consistent, which is beneficial to a generation of the fusion image by the fusion model, so that a processing speed of the fusion model may be increased, and a realism of the fusion image may be improved.

FIG. 7 schematically shows a block diagram of an apparatus of training a fusion model according to embodiments of the present disclosure.

As shown in FIG. 7, an apparatus 700 of training a fusion model may include a training fusion module 710, an attribution transformation module 720, and a training module 730.

The training fusion module 710 may be used to input a training source image and a training template image into a fusion model to obtain a training fusion image.

The attribution transformation module 720 may be used to perform an attribute alignment transformation on the training fusion image to obtain a training aligned image. An attribute information of the training aligned image is consistent with an attribute information of the training source image.

The training module 730 may be used to train the fusion model using an identity loss function. The identity loss function is generated for the training source image and the training aligned image.

According to embodiments of the present disclosure, the training module may include a joining unit and a training unit.

The joining unit may be used to determine a joint loss function based on the identity loss function and an attribute loss function. The attribute loss function is generated for the training fusion image and the training template image.

The training unit may be used to train the fusion model using the joint loss function.

According to embodiments of the present disclosure, the training unit may include a first acquisition sub-unit, a first input sub-unit, a second acquisition sub-unit, a second input sub-unit, and a training sub-unit.

The first acquisition sub-unit may be used to acquire a first identity information of the training source image and a second identity information of the training aligned image.

The first input sub-unit may be used to input the first identity information and the second identity information into the identity loss function to obtain an identity loss value.

The second acquisition sub-unit may be used to acquire a first attribute information of the training template image and a second attribute information of the training fusion image.

The second input sub-unit may be used to input the first attribute information and the second attribute information into the identity loss function to obtain an attribute loss value.

The training sub-unit may be used to train the fusion model based on the identity loss value and the attribute loss value.

According to embodiments of the present disclosure, the training fusion module may include a first training alignment unit, a second training alignment unit, and a training fusion unit.

The first training alignment unit may be used to perform a key point alignment on the training source image to obtain a training aligned source image.

The second training alignment unit may be used to perform a key point alignment on the training template image to obtain a training aligned template image.

The training fusion unit may be used to input the training aligned source image and the training aligned template image into the fusion model to obtain the training fusion image.

According to embodiments of the present disclosure, the attribute alignment transformation includes at least one selected from: a pose attribute alignment transformation, a makeup attribute alignment transformation, or an expression attribute alignment transformation.

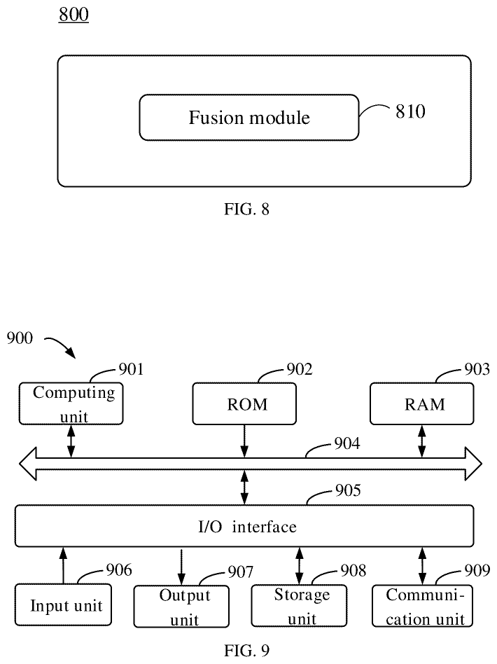

FIG. 8 schematically shows a block diagram of an apparatus of fusing an image according to embodiments of the present disclosure.

As shown in FIG. 8, an apparatus 800 of fusing an image may include a fusion model 810.

The fusion module 810 may be used to input an image to be fused and a template image into a fusion model to obtain a fusion image.

According to embodiments of the present disclosure, the fusion model may be trained by using the method of training the fusion model.

According to embodiments of the present disclosure, the fusion module may include a first alignment unit, a second alignment unit, and a fusion unit.

The first alignment unit may be used to perform a key point alignment on the image to be fused, so as to obtain an aligned to-be-fused image.

The second alignment unit may be used to perform a key point alignment on the template image to obtain an aligned template image.

The fusion unit may be used to input the aligned to-be-fused image and the aligned template image into the fusion model to obtain the fusion image.

According to embodiments of the present disclosure, the present disclosure further provides an electronic device, a readable storage medium, and a computer program product.

According to embodiments of the present disclosure, an electronic device is provided, including: at least one processor; and a memory communicatively connected to the at least one processor. The memory stores instructions executable by the at least one processor, and the instructions, when executed by the at least one processor, cause the at least one processor to implement the methods described above.

According to embodiments of the present disclosure, a non-transitory computer-readable storage medium having computer instructions therein is provided, and the computer instructions are used to cause a computer to implement the methods described above.

According to embodiments of the present disclosure, a computer program product containing a computer program is provided, and the computer program, when executed by a processor, causes the processor to implement the methods described above.

FIG. 9 schematically shows a schematic block diagram of an example electronic device 900 for implementing embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 9, the electronic device 900 includes a computing unit 901 which may perform various appropriate actions and processes according to a computer program stored in a read only memory (ROM) 902 or a computer program loaded from a storage unit 908 into a random access memory (RAM) 903. In the RAM 903, various programs and data necessary for an operation of the electronic device 900 may also be stored. The computing unit 901, the ROM 902 and the RAM 903 are connected to each other through a bus 904. An input/output (I/O) interface 905 is also connected to the bus 904.

A plurality of components in the electronic device 900 are connected to the I/O interface 905, including: an input unit 906, such as a keyboard, or a mouse; an output unit 907, such as displays or speakers of various types; a storage unit 908, such as a disk, or an optical disc; and a communication unit 909, such as a network card, a modem, or a wireless communication transceiver. The communication unit 909 allows the electronic device 900 to exchange information/data with other devices through a computer network such as Internet and/or various telecommunication networks.

The computing unit 901 may be various general-purpose and/or dedicated processing assemblies having processing and computing capabilities. Some examples of the computing units 901 include, but are not limited to, a central processing unit (CPU), a graphics processing unit (GPU), various dedicated artificial intelligence (AI) computing chips, various computing units that run machine learning model algorithms, a digital signal processing processor (DSP), and any suitable processor, controller, microcontroller, etc. The computing unit 901 executes various methods and processes described above, such as the method of fusing the mage and the method of training the fusion model. For example, in some embodiments, the method of fusing the mage and the method of training the fusion model may be implemented as a computer software program which is tangibly embodied in a machine-readable medium, such as the storage unit 908. In some embodiments, the computer program may be partially or entirely loaded and/or installed in the electronic device 900 via the ROM 902 and/or the communication unit 909. The computer program, when loaded in the RAM 903 and executed by the computing unit 901, may execute one or more steps in the method of fusing the mage and the method of training the fusion model described above. Alternatively, in other embodiments, the computing unit 901 may be used to perform the method of fusing the mage and the method of training the fusion model by any other suitable means (e.g., by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from a storage system, at least one input device and at least one output device, and may transmit the data and instructions to the storage system, the at least one input device, and the at least one output device.

Program codes for implementing the methods of the present disclosure may be written in one programming language or any combination of more programming languages. These program codes may be provided to a processor or controller of a general-purpose computer, a dedicated computer or other programmable data processing apparatus, such that the program codes, when executed by the processor or controller, cause the functions/operations specified in the flowcharts and/or block diagrams to be implemented. The program codes may be executed entirely on a machine, partially on a machine, partially on a machine and partially on a remote machine as a stand-alone software package or entirely on a remote machine or server.

In the context of the present disclosure, a machine-readable medium may be a tangible medium that may contain or store a program for use by or in connection with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory (RAM), a read only memory (ROM), an erasable programmable read only memory (EPROM or a flash memory), an optical fiber, a compact disk read only memory (CD-ROM), an optical storage device, a magnetic storage device, or any suitable combination of the above.

In order to provide interaction with the user, the systems and technologies described here may be implemented on a computer including a display device (for example, a CRT (cathode ray tube) or LCD (liquid crystal display) monitor) for displaying information to the user, and a keyboard and a pointing device (for example, a mouse or a trackball) through which the user may provide the input to the computer. Other types of devices may also be used to provide interaction with the user. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and the Internet.

A computer system may include a client and a server. The client and the server are generally far away from each other and usually interact through a communication network. The relationship between the client and the server is generated through computer programs running on the corresponding computers and having a client-server relationship with each other. The server may be a cloud server, a server of a distributed system, or a server combined with a block-chain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

1. A method of training a fusion model, the method comprising:
inputting a training source image and a training template image into a fusion model to obtain a training fusion image;
performing an attribute alignment transformation on the training fusion image to obtain a training aligned image, wherein an attribute information of the training aligned image is consistent with an attribute information of the training source image; and
training the fusion model using an identity loss function, wherein the identity loss function is generated for the training source image and the training aligned image.

2. The method according to claim 1, wherein the training the fusion model using an identity loss function comprises:
determining a joint loss function based on the identity loss function and an attribute loss function, wherein the attribute loss function is generated for the training fusion image and the training template image; and
training the fusion model using the joint loss function.

3. The method according to claim 2, wherein the training the fusion model using the joint loss function comprises:
acquiring a first identity information of the training source image and a second identity information of the training aligned image;
inputting the first identity information and the second identity information into the identity loss function to obtain an identity loss value;
acquiring a first attribute information of the training template image and a second attribute information of the training fusion image;
inputting the first attribute information and the second attribute information into the attribute loss function to obtain an attribute loss value; and
training the fusion model based on the identity loss value and the attribute loss value.

4. The method according to claim 1, wherein the inputting a training source image and a training template image into a fusion model to obtain a training fusion image comprises:
performing a key point alignment on the training source image to obtain a training aligned source image;
performing a key point alignment on the training template image to obtain a training aligned template image; and
inputting the training aligned source image and the training aligned template image into the fusion model to obtain the training fusion image.

5. The method according to claim 1, wherein the attribute alignment transformation comprises at least one selected from: a pose attribute alignment transformation, a makeup attribute alignment transformation, or an expression attribute alignment transformation.

6. A method of fusing an image, the method comprising:
inputting an image to be fused and a template image into a fusion model to obtain a fusion image,
wherein the fusion model is trained by using the method of training the fusion model according to claim 1.

7. The method according to claim 6, wherein the inputting an image to be fused and a template image into a fusion model to obtain a fusion image comprises:
performing a key point alignment on the image to be fused, so as to obtain an aligned to-be-fused image;
performing a key point alignment on the template image to obtain an aligned template image; and
inputting the aligned to-be-fused image and the aligned template image into the fusion model to obtain the fusion image.

8.-14. (canceled)

15. An electronic device, comprising:
at least one processor; and
a memory communicatively connected to the at least one processor, wherein the memory stores instructions executable by the at least one processor, and the instructions, when executed by the at least one processor, cause the at least one processor to at least:
input a training source image and a training template image into a fusion model to obtain a training fusion image;
perform an attribute alignment transformation on the training fusion image to obtain a training aligned image, wherein an attribute information of the training aligned image is consistent with an attribute information of the training source image; and
train the fusion model using an identity loss function, wherein the identity loss function is generated for the training source image and the training aligned image.

16. A non-transitory computer-readable storage medium having computer instructions therein, wherein the computer instructions are configured to cause a computer system to at least:
input a training source image and a training template image into a fusion model to obtain a training fusion image;
perform an attribute alignment transformation on the training fusion image to obtain a training aligned image, wherein an attribute information of the training aligned image is consistent with an attribute information of the training source image; and
train the fusion model using an identity loss function, wherein the identity loss function is generated for the training source image and the training aligned image.

17. (canceled)

18. The non-transitory computer-readable storage medium according to claim 16, wherein the computer instructions, when causing the computer system to train the fusion model using the identity loss function, are configured to cause the computer system to:
determine a joint loss function based on the identity loss function and an attribute loss function, wherein the attribute loss function is generated for the training fusion image and the training template image; and
train the fusion model using the joint loss function.

19. The non-transitory computer-readable storage medium according to claim 18, wherein the computer instructions, when causing the computer system to train the fusion model using the joint loss function, are configured to cause the computer system to:
acquire a first identity information of the training source image and a second identity information of the training aligned image;
input the first identity information and the second identity information into the identity loss function to obtain an identity loss value;
acquire a first attribute information of the training template image and a second attribute information of the training fusion image;
input the first attribute information and the second attribute information into the attribute loss function to obtain an attribute loss value; and
train the fusion model based on the identity loss value and the attribute loss value.

20. The non-transitory computer-readable storage medium according to claim 16, wherein the computer instructions, when causing the computer system to input the training source image and the training template image into the fusion model to obtain the training fusion image, are configured to cause the computer system to:
perform a key point alignment on the training source image to obtain a training aligned source image;
perform a key point alignment on the training template image to obtain a training aligned template image; and
input the training aligned source image and the training aligned template image into the fusion model to obtain the training fusion image.

21. The non-transitory computer-readable storage medium according to claim 16, wherein the attribute alignment transformation comprises at least one selected from: a pose attribute alignment transformation, a makeup attribute alignment transformation, or an expression attribute alignment transformation.

22. A non-transitory computer-readable storage medium having computer instructions therein, wherein the computer instructions are configured to cause a computer system to at least:
input an image to be fused and a template image into a fusion model to obtain a fusion image,
wherein the fusion model is trained by using the non-transitory computer-readable storage medium according to claim 16.

23. The electronic device according to claim 15, wherein the at least one processor, when training the fusion model using the identity loss function, is configured to:
determine a joint loss function based on the identity loss function and an attribute loss function, wherein the attribute loss function is generated for the training fusion image and the training template image; and
train the fusion model using the joint loss function.

24. The electronic device according to claim 23, wherein the at least one processor, when training the fusion model using the joint loss function, is configured to:
acquire a first identity information of the training source image and a second identity information of the training aligned image;
input the first identity information and the second identity information into the identity loss function to obtain an identity loss value;
acquire a first attribute information of the training template image and a second attribute information of the training fusion image;
input the first attribute information and the second attribute information into the attribute loss function to obtain an attribute loss value; and
train the fusion model based on the identity loss value and the attribute loss value.

25. The electronic device according to claim 15, wherein the instructions, when causing the at least one processor to input the training source image and the training template image into the fusion model to obtain the training fusion image, are further configured to cause the at least one processor to:
perform a key point alignment on the training source image to obtain a training aligned source image;
perform a key point alignment on the training template image to obtain a training aligned template image; and
input the training aligned source image and the training aligned template image into the fusion model to obtain the training fusion image.

26. The electronic device according to claim 15, wherein the attribute alignment transformation comprises at least one selected from: a pose attribute alignment transformation, a makeup attribute alignment transformation, or an expression attribute alignment transformation.

27. An electronic device, comprising:
at least one processor; and
a memory communicatively connected to the at least one processor, wherein the memory stores instructions executable by the at least one processor, and the instructions, when executed by the at least one processor, cause the at least one processor to at least:
input an image to be fused and a template image into a fusion model to obtain a fusion image,
wherein the fusion model is trained by using the electronic device according to claim 15.

28. The electronic device according to claim 27, wherein the instructions, when causing the at least one processor to input the image to be fused and the template image into the fusion model to obtain the fusion image, are further configured to cause the at least one processor to:
perform a key point alignment on the image to be fused, so as to obtain an aligned to-be-fused image;
perform a key point alignment on the template image to obtain an aligned template image; and
input the aligned to-be-fused image and the aligned template image into the fusion model to obtain the fusion image.
